(19) United States
(12) Patent Application Publication
(10) Pub. No.: US 2012/0141805 A1
(43) Pub. Date: Jun. 7, 2012

(54) Biological Functionalisation Of A Sol Gel Coating For the Mitigation Of Biofouling Microbial Induced Corrosion

(76) Inventors: Heming Wang, Sheffield (GB); Tom Smith, Sheffield (GB); Robert Akid, Sheffield (GB)

(21) Appl. No.: 12/677,221

(22) PCT Filed: Sep. 8, 2008
(86) PCT No.: PCT/GB2008/050796

§ 371 Date: Oct. 8, 2010

(30) Foreign Application Priority Data
Sep. 8, 2007 (GB) GB0717499.8

(51) Int. Cl. C09D 5/08; B05D 3/10; B32B 27/06; B32B 17/02; B32B 17/06; C09D 5/16; B32B 15/04

(52) U.S. Cl. 428/428; 106/14.44; 106/15.05; 427/384; 428/469; 428/450; 428/426; 428/446; 428/702

(57) ABSTRACT

A method of preparing a substrate using a sol-gel derived coating incorporating a microorganism. The coating is configured to inhibit microbial induced corrosion (MIC) and/or biofouling at the substrate-coating interface. The coating is prepared by mixing a sol with a suspension comprising the microorganism, applying the mixture onto a substrate followed by curing such that the resultant coating is chemically bonded to the substrate.

### FIELD OF THE INVENTION

The present invention relates to a method of preparing a substrate using a sol gel derived coating that incorporates a microorganism configured to inhibit biofouling and/or microbial induced corrosion at the substrate. The present invention also relates to a substrate comprising such a coating.

### BACKGROUND TO THE INVENTION

Microbiological induced corrosion (MIC) of metallic materials has received considerable attention over the last two decades. It is estimated that at least one-third of material loss arising from corrosion can be attributed to MIC activity, a process which costs industry millions of pound annually. Potentially MIC can have catastrophic consequences, for example, localised corrosion within aircraft fuel tanks. Furthermore, both aerated and oxygen starved environments can lead to the formation of various types of metabolites which directly participate in electrochemical reactions that lead to the establishment of local corrosion cells. The role of sulphate-reducing bacteria (SRB) in MIC is well established and, in addition, enhanced corrosion or corrosion inhibition can be obtained during the formation of biofilms containing other classes of bacteria. For example, corrosion of iron and nickel has been reported to increase in the presence of Pseudomonas sp. S9 and Serratia marcescens sp. EF 190. On the other hand, some bacterial strains including Pseudomonas fragi, Escherichia coli DH5, Pseudomonas flava and Paenibacillus polymyxa are known to inhibit corrosion when they reside in biofilms.

MIC is particularly prolific in water systems such as in tidal barriers which experience considerable corrosion of the metal components of the barriers due to MIC activity.

One prior art method aimed at preventing microbe influenced corrosion has been to add biocides to water systems in a direct attempt to limit or mitigate the development of surface biofilms within which microbes secrete highly aggressive acidic or alkaline compounds.

The efficacy of this approach is dependent upon (a) the biocide being delivered to all water-metal substrate interaction sites and (b) the biocide remaining active therein preventing biofilm development/growth. These biocides are both hazardous to the environment for example tri-butyl tin is toxic to aquatic life, as well as to anyone working in the immediate vicinity. They are also known to be relatively ineffective against bacteria protected in a biofilm on the surface of the corroding metal.

In a further method of corrosion inhibition, bacteria are cultivated in rich growth media and then added to a metal substrate. The bacteria protect the metal substrate against corrosion by colonising on the surface of the metal. In this way, it has been shown that the colonising bacteria inhibit corrosion on the metal surface however, these tests have been carried under laboratory conditions where environmental microbes are excluded. Therefore, it is highly unlikely that this method of corrosion protection will be successful in real environments given the presence of further harmful microbes which could disrupt the colonising of the bacteria on the surface of the metal.

The inventors have sought to provide a novel mixture which successfully inhibits corrosion at the interface of a substrate to which the mixture is applied as a coating when the coated material is placed in a real environment, for example in water systems. Furthermore, the inventors have sought to overcome the existing problems associated with use of biocides, as mentioned above, in that they have attempted to produce a mixture which has minimal adverse effects on the environment or anyone working within the immediate vicinity. They have also sought to produce a mixture that, when used as a coating infiltrates previously formed biofilms on the surface of the corroding substrate thereby inhibiting further corrosion.

### SUMMARY OF THE INVENTION

An object of the present invention is to provide a novel way of protecting a substrate against the development of local environments that would favour the formation of harmful biofilms at the interface of the substrate and so reduce corrosion (in particular MIC) and biofouling.

According to a first aspect of the present invention there is provided a method for preparing a substrate, the method comprising: preparing a sol comprising an inorganic oxide particulate; preparing a suspension comprising a microorganism wherein the microorganism is immobilised within the suspension; mixing the sol and the suspension together to form a mixture; coating the substrate with the mixture; and curing the mixture on the substrate to form a sol-gel derived coating chemically bonded to the substrate; wherein the microorganism maintains viability within the coating to inhibit microbial induced corrosion or biofouling at the substrate.

The mixture can be applied as a coating to a range of substrates, such as outdoor structures including but not limited to civil engineering structures, marine structures, marine vessels, aircraft, vehicles, and like structures which are exposed to weather or corrosive environments. In particular, the present coating is suitable for application onto metal based substrates in addition to polymer, plastics, fibreglass and other non-metal based substrates that find application in the above environments.

It is advantageous to prepare two separate components according to the above method as it enables the components to be stored separately for long periods of time prior to mixing and subsequent application as a coating to the surface of the substrate. The components are stable in their given environments and so will be equally as effective if used when it is first prepared, or used after storing for a period of time.

Furthermore, as the two components are prepared separately, it is possible to optimise the sol for thickness, curing times and density etc. and optimise the suspension to provide an optimised environment for the biological or other corrosion/biofouling-inhibiting activity of the microorganism. In this way, any components of the sol which may be detrimental to the biological or other activity of the microorganism can be isolated and stabilised before mixing of the sol and suspension prior to coating the substrate.

The components of the sol are selected to provide optimum environmental conditions for the microorganism of the suspension. In particular the pH is sufficiently neutral to permit survival of the microorganism and the temperature at which the mixture is cured is around room temperature but not in excess of 120° C. Furthermore, the composition of the sol-gel preferably excludes any components which may be detrimental to the biological or other corrosion/biofouling inhibiting activity of the microorganism, for example, solvents and metal oxides. These conditions have been selected so that the microorganism maintains its viability in order to successfully inhibit or prevent corrosion/biofouling of the substrate.

By viable it is meant that the microorganism maintains some metabolic activity, however it does not necessarily mean that it is still culturable. Indeed, the below experimentational work has shown that the mixtures of the present invention provide protection against corrosion/biofouling when there is relatively little evidence of the microorganism growing or respiring. Therefore, there is no absolute requirement for the microorganism to be growing.

Preferably said mixture is configured to inhibit corrosion and/or biofouling at the interface of a substrate.

One purpose of the microorganism is to prevent MIC which is a result of the presence of harmful bacteria on the surface of a metal type substrate.

The inventors believe that the protective nature of the mixture may be due to the biological activity of the microorganism or due to the coating providing an extra barrier against corrosion/biofouling due to the take up of water and oxygen by the biologically active agent which prevents these elements from reaching the surface of the substrate and thus causing corrosion/biofouling.

Preferably said method further comprises a step of curing said mixture, said mixture being cured at a temperature of less than or equal to 120° C. More preferably said mixture is cured at a temperature of less than 50° C. In the most preferred embodiment of the present invention said mixture is cured at room temperature.

The microorganism may be immobilised by means of encapsulation of said microrganism in said mixture.

Preferably said microorganism may comprise prokaryotic cells such as archaeic cells or bacterial cells. For example at the time of immobilisation said microorganism may comprise vegetative bacterial cells, endospores or cells in some other quiescent state. When said microrganism is in the form of vegetative cells, it is preferable that the vegetative cells are Pseudomonas fragi. The bacterial cells may alternatively be endospores such as those of Paenibacillus polymyxa. Paenibacillus polymyxa are endospore-forming organisms which produce at least one antimicrobial compound which kills bacteria associated with MIC.

The microorganism is selected for its ability to survive in harsh conditions, in terms of the pH, temperature and solvent content of the coating.

In a preferred embodiment of the present invention, the suspension may be added to the sol in the volume ratio of 1:10.

Preferably, said mixture is aqueous. The mixture may have a pH within the range of from 4 to 10, preferably the mixture has a pH of 7.

The inorganic oxide particulates present in the sol may be metal oxide nanoparticles such as alumina-based nanoparticles. Alternatively, the inorganic oxide particulates may be silica-based nanoparticles, for example an ormosil or an ormosil hybrid.

In a preferred embodiment of the present invention, the inorganic oxide particulates comprise a mixture of tetraethylorthosilicate, methyltrimethoxysilane and 3-glycidoxypropyltrimethyoxysilane in the ratio 10:6:1.

Optional further components of the sol and suspension may include a buffering agent in the suspension and a curing agent and/or thickening agent in the sol.

The substrate to which the mixture of the present invention is applied as a coating may be metal-based, and comprises any one or a combination of the following:
iron
aluminium
titanium
copper
silver

In particular, the substrate may be a metal alloy selected from any one or a combination of the following:
steel
aluminium alloy
stainless steel
titanium alloy
copper alloy
magnesium alloy
silver alloy

Specifically, the mixture and the resultant coating of the present invention is configured to inhibit the development of microbial induced corrosion, for example corrosion caused by sulphate reducing bacteria. Alternatively, the mixture may be configured to inhibit accelerated low water corrosion.

The substrate to which the mixture of the present invention is applied as a coating may be plastic, polymer or fibreglass based. Additionally, the substrate may comprise a combination of these materials including a plastics-metal or fibreglass-metal hybrid substrate.

According to a second aspect of the present invention there is provided a substrate comprising a coating configured to protect the substrate from microbial induced corrosion or biofouling: the coating comprising: a sol-gel derived inorganic oxide network resultant from condensation reactions between inorganic oxide particulates; and a microorganism incorporated within the coating, the microorganism capable of reacting chemically with microbes responsible for microbial induced corrosion or biofouling and configured to inhibit the biological activity of said microbes.

When the microorganism is in the form of biologically active vegetative cells at the time of immobilisation a buffering agent is incorporated into the mixture of the present invention in order to prevent the microorganism from lysing upon introduction into an aqueous solution.

Selection of the curing agent is dependent on the microorganism used within the suspension as it should not be detrimental to the metabolic activity of the microorganism.

Upon mixing of the sol and suspension, the components of the suspension diffuse into the sol creating a semi-homogenous solution. In this way the mixture has a uniform corrosion inhibiting nature throughout the thickness of the coating. The microorganisms may react with the components of the sol, forming bonds and causing chemical reactions to take place, for example condensation reactions.

A silica based sol-gel, such as an ormosil or ormosil hybrid based sol-gel, is preferable as the interactions between the mixture and the substrate enables optimum corrosion inhibition conditions.

The term ‘biofouling’ used within this specification refers to the accumulation of microorganisms on exposed and/or structures that are submerged in for example aqueous environments. The term ‘biofouling’ includes microfouling, macrofouling and biofilm formation.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 herein illustrates schematically the formation of a corrosion inhibiting sol-gel derived coating according to a first and second embodiment of present invention;

FIG. 2 herein shows the Environmental Scanning Electron Microscopy (ESEM) image of the bacterial distribution of a corrosion inhibiting coating according to the first embodiment of the present invention;

FIG. 3 herein shows the Atomic Force Microscopy (AFM) image of the bacteria encapsulation in a sol-gel coating according to the first embodiment of the present invention;

FIG. 4 herein shows the AFM image of the a sol-gel coating according to an embodiment of the present invention with γ-Al₂O₃;

FIG. 5 herein shows the fluorescence microscopy image of an ethidium bromide stained sol-gel coating according to the first embodiment of the present invention;

FIG. 6 herein shows a typical cross-section of a sol-gel coating according to the second embodiment of the present invention;

FIG. 7 herein illustrates a plot of Linear Polarisation Resistance (LPR) against time for a bare Al alloy substrate, an Al alloy substrate coated with a control sol-gel without added bacteria, an Al alloy substrate coated with a corrosion inhibiting sol-gel derived coating according to a first embodiment of present invention and a substrate coated with corrosion inhibiting sol-gel derived coating according to a second embodiment of present invention over a 30 day immersion period in nutrient-rich Artificial Sea Water (ASW);

FIG. 8 herein illustrates a Nyquist plot for a bare Al alloy substrate, an Al alloy substrate coated with a control sol-gel, an Al alloy substrate coated with a corrosion inhibiting sol-gel derived coating according to a first embodiment of present invention and a substrate coated with corrosion inhibiting sol-gel derived coating according to a second embodiment of present invention after 30 days immersion in nutrient rich ASW;

FIG. 9 herein illustrates schematically a Bode plot for a bare Al alloy substrate, an Al alloy substrate coated with a control sol-gel, an Al alloy substrate coated with a corrosion inhibiting sol-gel derived coating according to a first embodiment of present invention and a substrate coated with corrosion inhibiting sol-gel derived coating according to a second embodiment of present invention after 30 days immersion in nutrient-rich ASW;

FIG. 10 herein illustrates schematically a plot of Electrochemical current noise against time for an Al alloy substrate coated with a control sol-gel and an Al alloy substrate coated with a corrosion inhibiting sol-gel derived coating according to a first embodiment of present invention after 30 days immersion in nutrient-rich ASW;

FIG. 11 herein illustrates schematically a plot of Electrochemical current noise against time for an Al alloy substrate coated with a control sol-gel and an Al alloy substrate coated with a corrosion inhibiting sol-gel derived coating according to a second embodiment of present invention after 30 days immersion in nutrient-rich ASW;

FIG. 12 herein shows an image of a Rhodamine 123-stained Al alloy substrate coated with a corrosion inhibiting sol-gel derived coating according to a first embodiment of present invention after 30 days immersion in nutrient-rich ASW;

FIG. 13 herein shows a fluorescence microscopy image of ethidium bromide stained Al alloy substrate coated with a corrosion inhibiting sol-gel derived coating according to a first embodiment of present invention after 30 days immersion in nutrient-rich ASW;

FIG. 14A herein shows standard optical observations for a) a substrate coated with a corrosion inhibiting sol-gel derived coating according to a second embodiment of present invention; b) a bare substrate; and c) a substrate coated with a control sol-gel; after six months immersion in a tidal estuarine environment; and

FIG. 14B herein shows Scanning Electron Microscopy (SEM) images for d) a substrate coated with a corrosion inhibiting sol-gel derived coating according to a second embodiment of present invention and e) a bare substrate after six month immersion in a tidal estuarine environment.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practised without limitation to these specific details. In other instances, well known methods and structures have not been described in detail so as not to unnecessarily obscure the description.

In this specification, the term “sol” refers to a dispersion of solid particles in liquid phase, the particles being small enough to remain suspended indefinitely.

In this specification, the term “gel” refers to a solid containing a liquid component in an internal network structure whereby both the liquid and solid are arranged in a highly dispersed state.

During this experimentation, a robust and room-temperature cured sol-gel coating comprising the encapsulation of bacteria was produced and deposited onto an Al 2024-T3 alloy substrate material. The corrosion performance of the coating was evaluated based on the use of conventional AC/DC electrochemical test methods. DC linear polarisation resistance (LPR) can be used to evaluate the corrosion performance of metals and alloys by perturbing the natural open circuit potential of the system in both the positive (anodic) and negative (cathodic) sense. The resulting corrosion current is measured and, using Ohms law, the resistance to corrosion is determined. The LPR value of interest is designated as Rₚ, and is related to the corrosion rate, i_{corr}, based upon equation 1.

$${i}_{corr} = \frac{{B}_{a} {B}_{c}}{2.3 {R}_{p} ( {B}_{a} + {B}_{c} )} \qquad ( 1 )$$

The values Bₐ and B_{c} are the anodic and cathodic Tafel constants derived from polarisation curves conducted under identical substrate/electrolyte conditions.

Similarly the resistance to corrosion can be derived from Electrochemical Noise Analysis (ENA) or Electrochemical Impedance Spectroscopy (EIS).

Fluorescence microscopy was used to observe bacterial cells within and on the surface of the sol-gel derived coatings during the corrosion trials. Preliminary observations relating bacterial activity to corrosion damage were made using Fluorescence microscopy.

### Abiotic and Bioactive Coating Preparation

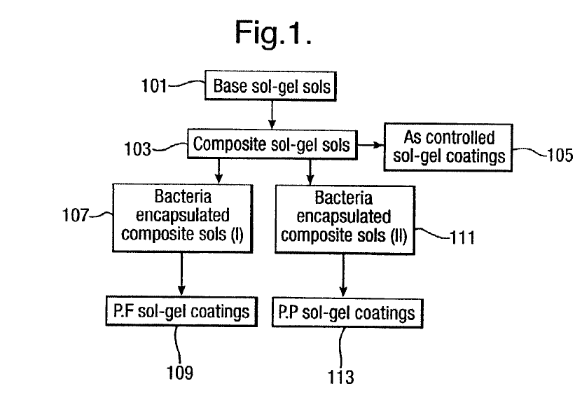

Two strains of bacteria, namely Pseudomonas fragi ATCC 4973 (PF) and Paenibacillus polymyxa ATCC 10401 (PP) were chosen for encapsulation within the sol-gel matrix. PF was incorporated into the sol-gel matrix in the form of vegetative cells. PP was incorporated into the sol-gel matrix in the form of endospores. The sol-gel coating processing route is shown in FIG. 1.

The base sol-gel sol 101 was prepared firstly by mixing tetraethylorthosilicate, methyltrimethoxysilane, and glycidoxypropyltrimethoxysilane in ethanol according to the ratio of 10:6:1. Deionised water was added drop wise into the base sol-gel sol 101 at 50˜80° C. Glacial acetic acid was also added as the catalyst to promote hydrolysis and condensation reactions. The pH value of the prepared sol 101 was adjusted to a suitable value in the range 4˜6 to accommodate the living precondition of the added bacterial strains.

To increase the hardness of the coatings 109 and 113, 3˜5% γ-AI2O3 was mixed with the as-prepared base sol 101 to obtain a stable composite sol 103. γ-Al₂O₃ is an inert material which does not alter the bacterial activity of the overall coatings 109 and 113.

The composite sol 103 was separately dip-coated onto the Al 2024-T3 alloy substrate; typical composition, % by Weight, Cu: 4.5; Mg: 1.5; Mn: 0.6; Remainder Al. These samples constituted the ‘control’ coated samples.

PF and PP encapsulated sol-gel coatings 109 and 113 were applied to the Al alloy substrate by adding either the PF or PP bacteria into the composite sols 103 in the ratio of 1:10. All bacterial cultures were grown at 30° C. Strains were propagated using Nutrient Broth no. 2 agar.

PF cells for immobilisation in the PF sol-gel coating 109 were prepared by adding a fresh 5-mL overnight liquid starter culture to 1 litre of NB and incubating with shaking (150 rpm) for 16 h, after which the cells were harvested by centrifugation (8,300 g, 10 min, 4° C.) and resuspended in phosphate buffered saline solution (pH 7.4; available from Fluka) to give 15 mL of bacterial suspension at an optical density at 600 nm, OD₆₀₀=135 that was stored at 4° C. for up to 3 days until used.

Endospores of PP for immobilisation in the PP sol-gel coating 113 were prepared by streaking an inoculum across the whole surface of 12×9 cm-diameter plates of NB agar supplemented with 0.1% (v/v) of CCY sporulation medium trace elements solution. After 7 days incubation at 30° C., sporulation was confirmed by phase contrast microscopy and the endospores were harvested by flooding each plate with 10 mL of ice-cold sterile water and dislodging the colonies from the plates using a sterile plastic inoculating loop. The pooled endospore-containing suspension was centrifuged (39,000 g, 5 min, 4° C.) and the pellet was washed five times with deionised water by resuspension and centrifugation under the same conditions. The washed pellet was resuspended in 1 mL of deionised water and sonicated (25 s using a Jencons CV33 probe sonicator on 40% full power, fitted with a 3 mm diameter tip) in order to separate the aggregated endospores. Remaining vegetative cells were killed by vortexing with 0.2 mL of water-saturated chloroform, to give an endospore suspension that had OD₆₀₀=66.

It is recognised that the optical densities of the PF sol-gel coating 109 and the PP sol-gel coating 113 are different although it should be noted that the spores of PP are significantly smaller than the cells of PF. However the cell densities were considered to be comparable.

The sol-gel formulations of each bacterium always contained the same density of the cells of that bacterium, (i.e. PF sol-gel coatings 109 had the same cell density as all other PF sol-gel coatings 109 and PP sol-gel coatings 113 had same cell density as all other PP sol-gel coatings 113).

The bioactive coating solutions 109 and 113 were prepared by mixing the bacteria suspension and the composite sol gel solution 103. In the case of the endospore PP sol-gel coatings 113, the problem of spore suspension was overcome by using a probe sonicator (5 s, 0° C.) immediately before the addition of the composite sol gel solution 103. Examination of the spores after sonication, using the phase-contrast microscope, confirmed that the sonication had not disrupted the spores, which remained phase-bright.

### Microscopy of Coatings

Examination of the PF and PP sol-gel coatings 109 and 113 both before and after testing within the ASW was conducted using the following; (a) an Environmental Scanning Electron Microscope, ESEM, (Phillips XL30 ESEM) under “wet” mode using a 12.0 kV excitation voltage and 4.0 Torr vacuum, (b) Atomic Force Microscope Nanoscope Ilia, (AFM) operating in contact mode, (c) an Olympus BX60 fluorescence microscope operating in reflected light fluorescence mode and fitted with a U-MWG filter cube giving green excitation; and (d) a Meiji Techno Co. Ltd. VPS6 standard light optical microscope.

### Corrosion Testing Set Up & Electrochemical Tests

Evaluation of the corrosion protection offered by the PF and PP sol-gel coatings 109 and 113 was carried out on the Al alloy substrate using DC Linear Polarisation Resistance (LPR) measurements, AC Electrochemical Impedance Spectroscopy (EIS) and Electrochemical Noise Analysis (ENA). All experiments reported here were carried out using an ACM Instruments Gill AC potentiostat with an integral frequency response analyser; utilising a Femto Amp paint buffer that broadens the frequency range of the instrument.

In all cases, the reference electrode used was a saturated (KCl) calomel electrode. Individual specimens had different surface areas ranging between 9.5 cm² and 10 cm². The edges of the specimens were masked with an air-drying solvent-thinned (toluene) acrylic compound to counter any effects of bare substrate material due to lack of edge coating. For comparison a set of tests were conducted using sol gel coated AA 24 samples within the nutrient-rich ASW environment to which a suspension of PP was added. These tests, designated sessile tests, were carried out to evaluate the effect of freely available bacteria on the corrosion performance of the abiotic sol gel coating system therein allowing an evaluation of the difference between the inhibiting effect of encapsulated and non-encapsulated bacteria.

Specimens were exposed to ASTM D1141-75 Artificial Sea Water (ASW) containing nutrients, see table 1. In order to exclude the possibility of visible light-induced damage to the bacterial cells and endospores and to prevent growth of photosynthetic microorganisms, the vessels containing the test panels were kept in the dark for the period of the exposure except for the brief time required to acquire the electrochemical data.

Several LPR measurements were made, using a ±20 mV scan range, at various intervals over the 30-day exposure period and recorded as a function of time. Electrochemical measurements were made immediately prior to the removal of the specimens from the test solution. After removal, the specimens were examined for microbial distribution and activity by staining with ethidium bromide (10 μg mL⁻¹) or by treating with EGTA (0.1 mM) for 35 min, followed by staining with rhodamine 123 (5 μg mL⁻¹) for 1 h. At the same time, LPR measurements were made for the specimen that would subsequently be removed at the next allocated interval; following this procedure two data points were obtained for each selected time interval.

The experimental parameters for the EIS experiments were as follows: a voltage perturbation about the open circuit potential of 10 mV using a frequency range of 20 kHz-10 mHz with 75 data points distributed logarithmically. A cell settle time of 30 seconds was used for each test. Each set of EIS results contains data sets acquired from the same panel at exposure times of 1, 3, 16 and 30 days. Note the sessile test data was acquired at exposure times of 1, 2, 4, 5 and 12 days. Curve fitting was carried out using both the routine within the ACM software and the ZSimpWin software produced by Princeton Applied Research. The ACM software provides a quick reference value for a particular semi-circle on a Nyquist plot whilst detailed equivalent circuit analysis may be carried out with the latter which additionally assesses the implications of both the bode and phase angle plots.

ENA measurements were carried out with a sampling frequency of 0.1 Hz over 20,000 data points. ENA data was gathered using two nominally identical working electrodes immersed in the same solution. As with the EIS experiments, the data was gathered on day 1, 3, 16 and 30 or day 1, 2, 4, 5 and 12 for the sessile test. Noise measurements have been primarily used to detect the onset of localized corrosion and to monitor its progress in a qualitative manner. ENA has also been explored as a technique for determining corrosion rates and has shown much promise in this capacity. ENA is sensitive to transients in the corrosion potential and current and can detect when biofilm activity changes and reaches a steady-state. Electrochemical noise is commonly defined as stochastic fluctuations of the corrosion potential and corrosion current spontaneously generated by corrosion reactions. Fluctuations of noise resistance, Rₙ, is given by;

$${R}_{n} = \frac{σ [ V ( t ) ]}{σ [ I ( t ) ]} \qquad ( 2 )$$

where σ[V(t)] is the standard deviation of the potential fluctuations and σ[l(tj] is the standard deviation of the current fluctuations. Low frequency drift in the potential or current has been shown to affect the accuracy of the statistical analysis of ENA data. No drift was observed in the ENA data obtained in the present study.

### Results

### Bacterial Distribution of Biotic Sol Gel Coatings

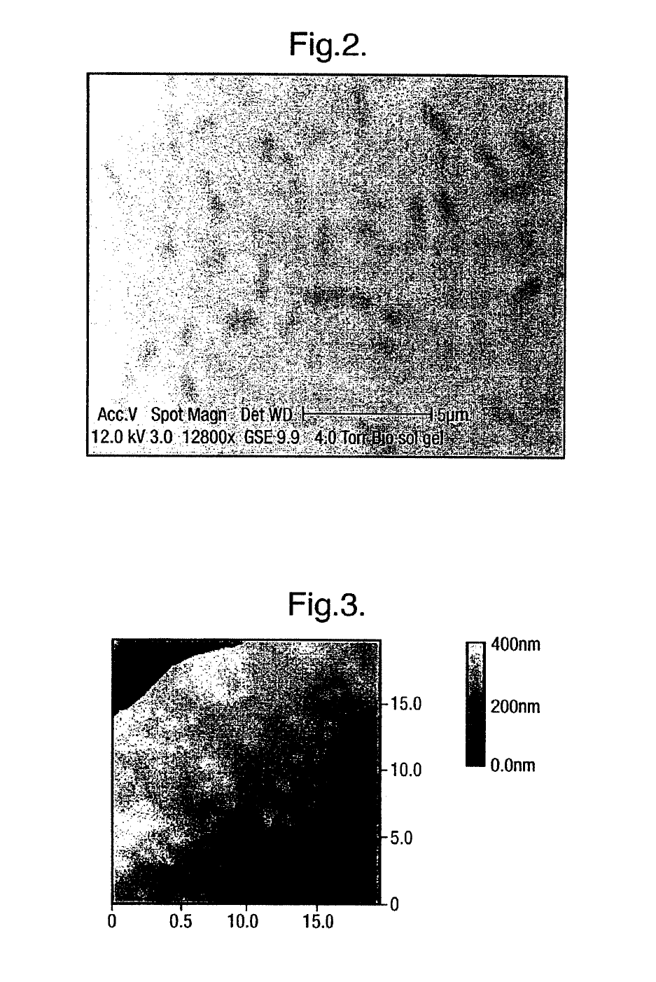

Examination of the PF bacteria-loaded samples was conducted using both ESEM and AFM methods. The results of this examination are shown in FIGS. 2, 3 and 4. Referring to FIGS. 2, 3 and 4 herein, there is shown (a) ESEM and (b) AFM images showing PF bacteria encapsulation in the sol gel coating (glass slide substrate) and, (c) AFM image of the PF sol gel coating 109 with 7-AI2O3 on an Al 2024 substrate respectively.

From these figures it can be seen that the cells of the PF bacteria are very uniformly dispersed within the film and are rod-shaped cells of around 1.6×0.5 μm.

Referring to FIG. 5 herein, there is illustrated fluorescence microscopy of ethidium bromide stained coating containing PF bacteria 109 on an Al 2024 substrate showing bacterial cell distribution 501. This image shows a similar uniform distribution of the PF cells to those in FIGS. 2, 3 and 4. Field of view shows a surface, on Day 1 that was fully immersed in artificial seawater.

This method of fluorescence microscopy relies on the staining by ethidium bromide of bacteria with cell membrane damage and therefore is not necessarily the most appropriate reliable method of assessing bacteria density within the coating as is evidenced from the slight differences in apparent population seen in FIGS. 2, 3 and 4 and FIG. 5.

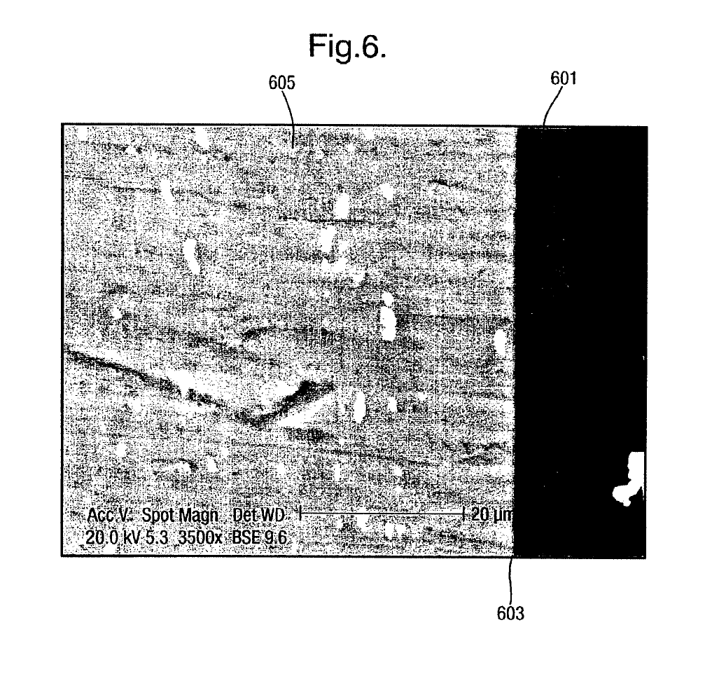

Referring to FIG. 6 herein, there is shown a typical cross section of a PP sol gel coating 601 in position at the interface 603 of a Al 2024 substrate 605. This image shows that the PP sol gel coating 601 has a typical thickness of around 5-7 microns and a uniform distribution of bacteria within the coating 601.

The adhesion of the sol gel coating to the interface of the substrate has been found to be very good and capable of being subject to a 180 degree bend without loss of adhesion. Furthermore, examination of the field trial samples after 6 months tidal immersion did not reveal any disbonding of the sol gel coating from the substrate.

### Electrochemical Tests

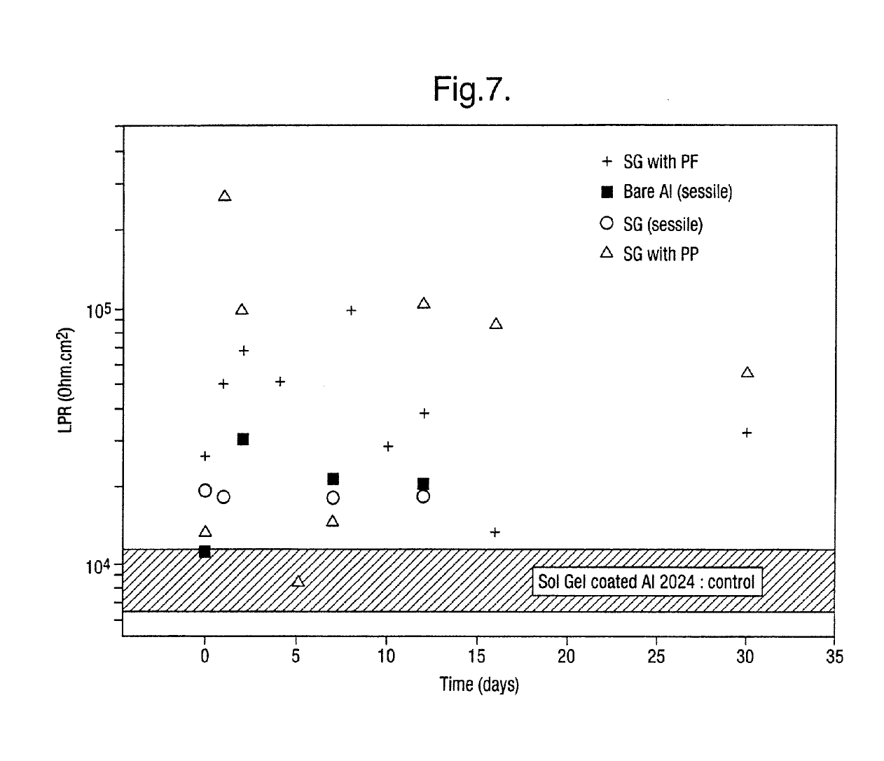

Referring to FIGS. 7 to 9 herein, there is shown a summary of the electrochemical tests conducted on the abiotic and doped sol gel coatings within the nutrient rich ASW with and without added planktonic (freely suspended) bacteria.

FIG. 7 shows LPR data as a function of immersion time for Al 2024 substrate. The hatched area represents the min/max range of LPR values obtained over a 30 day period for a sol gel coated Al 2024 substrate in nutrient-rich ASW.

LPR measurements were taken for nominally identical samples over the 30 day immersion period. Two measurements at each selected time interval were taken for each sample and the average value of these two data points was used to assess the corrosion performance. Analysis of the data for the Al alloy was made and is presented in FIG. 7. The shaded regions in FIG. 7, represent the min/max LPR values obtained for the control samples, that is, the abiotic sol gel coating, during the 30 day immersion period.

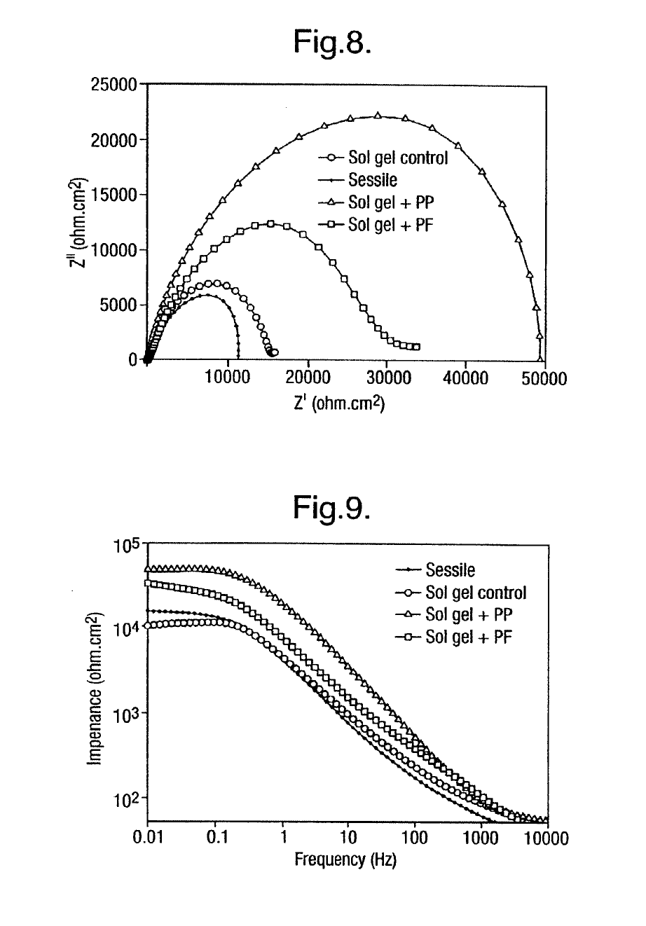

Referring to FIGS. 8 and 9 herein, there is shown Impedance data showing (a) Nyquist and (b) Bode plots respectively for different sol gel systems after 30 days immersion in ASW. Note “sessile test” data represents 12 days immersion only.

EIS measurements were taken shortly after the acquisition of the LPR data at the following intervals; 1, 3, 16 and 30 days. In the case of the “sessile test”, EIS data was recorded at 1, 2, 4, 8 and 12 day intervals. The results of the impedance measurements were analysed using ACM curve fitting routines and ZSimpWin software and are given in FIGS. 8 and 9. In these figures both PF and PP bacterial-loaded coatings are compared along with the sol gel control coating with and without the presence of immobilised PP bacteria.

Analysis of the data obtained from the EIS experiments was carried out to obtain the charge transfer resistance for each test condition. Table 2 presents a summary of charge transfer resistance values at day 30 for sol gel-Al 2024 systems obtained from EIS analysis.

| | Abiotic | Abiotic SG in | PF | PP |
|---|---|---|---|---|
| | SG in | ASW + sessile | loaded SG | loaded SG |
| System | ASW | PP* | In ASW | in ASW |
| RCT(ohms · cm²) | 1.39 × 10⁴ | 9.23 × 10³ | 2.35 × 10⁴ | 5.01 × 10⁴ |

*Note “sessile” tests represent 12 days immersion only.

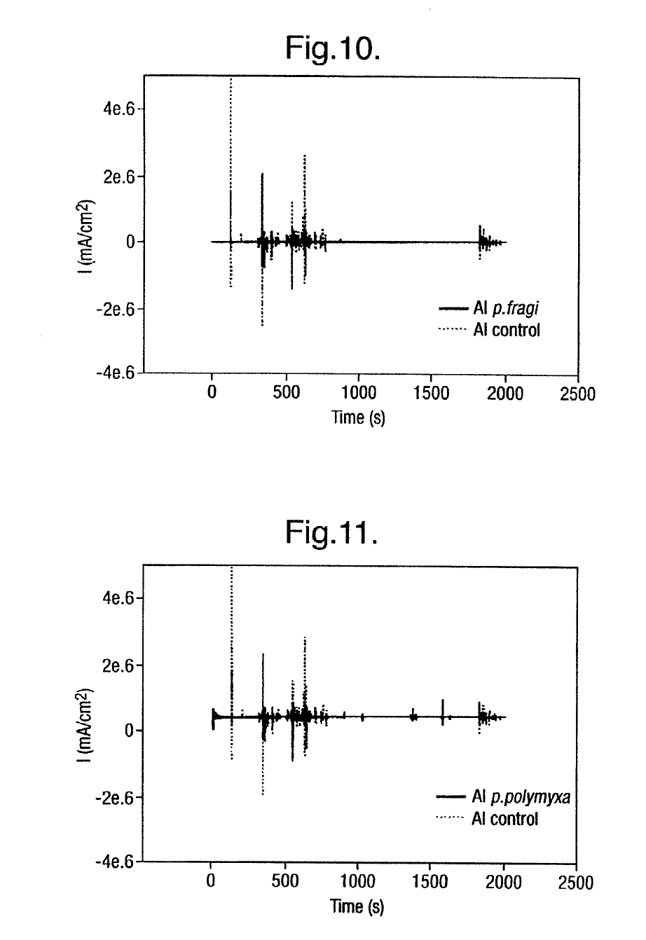

Referring to FIG. 10 herein, there is shown current noise data for PF encapsulated sol gel coating and control sol gel coated Al 2024 after 30 days of immersion in artificial seawater. FIG. 11 herein shows current noise data for PP encapsulated sol gel coating and control sol gel coated Al 2024 after 30 days of immersion in artificial seawater. The same ‘control sample’ data has been used for each comparison.

Electrochemical current noise data comparing the abiotic coating with the coatings containing PF or PP are presented in FIGS. 10 and 11 respectively, following a 30 day immersion period. As shown in these figure, there was a clear distinction between the number of current fluctuations for the abiotic coating and the relatively few fluctuations in the current data for the bacteria laden coating. This difference suggests a much greater number of localized corrosion events for the abiotic coating.

### Microscopic Observations on the Extent of Corrosion

Post immersion observation of the laboratory and field trials was carried out using Optical, Fluorescence and Scanning Electron Microscopy.

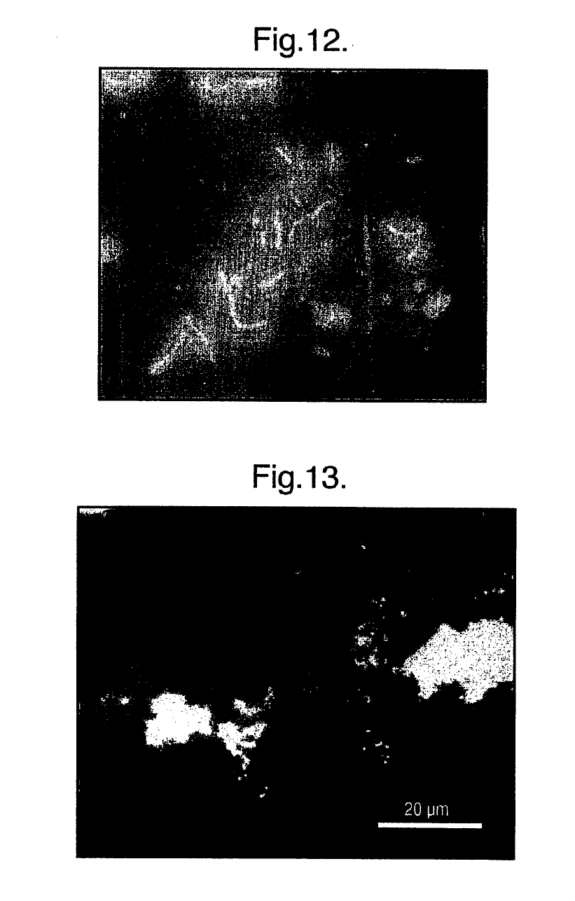

Referring to FIG. 12 herein, there is shown a Rhodamine 123-stained sample with sol-gel coating containing PF, after 2 days immersion.

Staining of the sol gel coated Al sample with rhodamine 123 after 2 days immersion in the artificial seawater indicated that the only detectable bacterial metabolic activity was around the meniscus of the seawater, where the cells that fluoresced (indicating metabolic activity) were elongate, see FIG. 12. This is suggestive of the same filamentation seen when the PF was grown in NB medium made up in the artificial seawater.

Referring to FIG. 13 herein, there is shown a Fluorescence microscopy of ethidium bromide stained coating that was loaded with PF bacteria on an Al substrate, showing bacterial cell distribution on day 30. Field of view shows a surface that was fully immersed in artificial seawater. Differential focusing of the microscope suggested that the fluorescing bacterial cells were on the surface of the coating.

Fluorescence microscopy of the PF-containing sample at day 30 of the test, see FIG. 13, indicated some colonisation of the surface of the coating by new rod-shaped bacterial cells. Note the field of view shows the region immediately above the meniscus of the artificial seawater in which the fluorescing, metabolically active bacterial cells, are elongated.

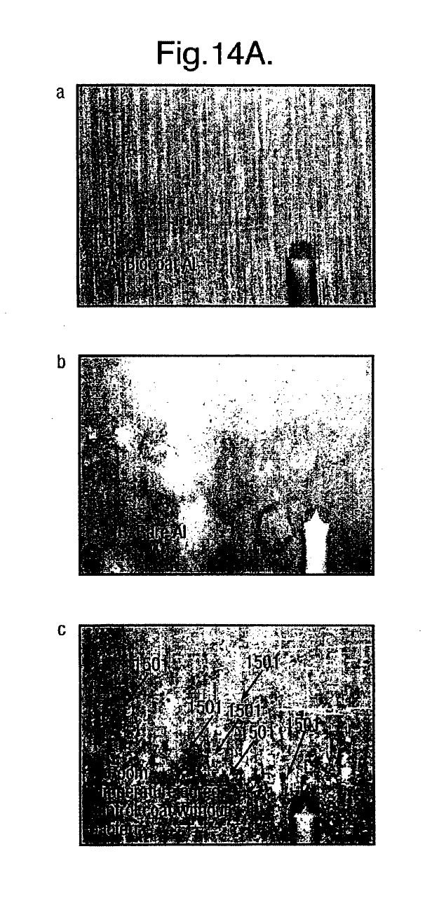

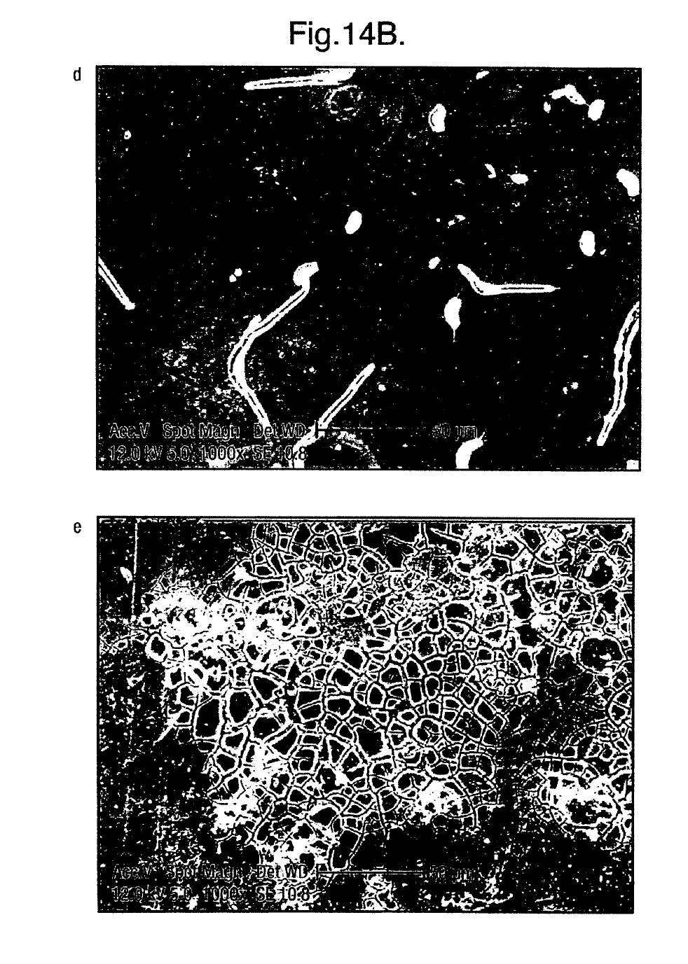

The beneficial effects of encapsulating PP into the sol gel coating is further illustrated from optical and detailed SEM examination of the field trial samples, retrieved after 6 months immersion in a tidal estuarine environment in FIGS. 14A and 14B.

FIG. 14A shows three samples, namely a) room temperature cured sol gel with encapsulated PP; b) Bare Al alloy substrate; c) room temperature cured sol gel without PP. These images show that there is a clear difference in the degree of damage between the two types of coating with the area of corrosion on the biotic coating being orders of magnitude less than that of the control sample.

Arrows 1501 on control sol gel without PP sample c), indicate areas of localised corrosion.

Referring to FIG. 14B herein there is shown field trial samples showing comparison of corrosion damage after 6 months immersion in a tidal estuarine environment. SEM photos d) and e) are high magnification images taken from surfaces of a) and b) in FIG. 14A respectively. Note the scale marker is identical for all optical images. SEM image scale marker (50 μm) representative of both images.

### Morphology of Sol Gel Coatings

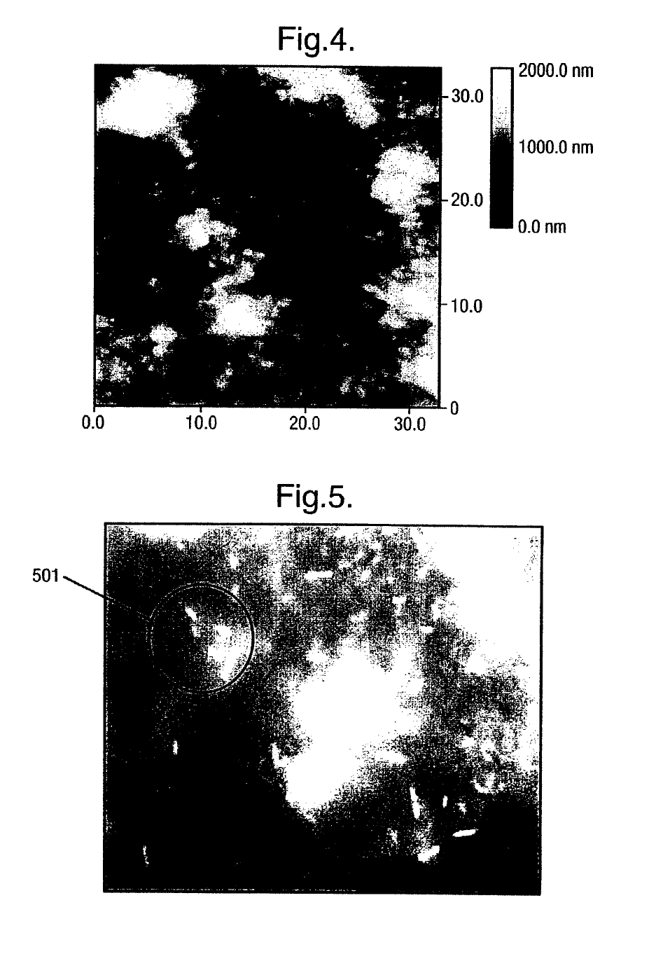

The morphology of sol-gel coatings on the glass slide, without the inclusion of γ-Al₂O₃ nanoparticles is very smooth, as shown in FIGS. 2 and 3. In this case, the encapsulated cells of the PF bacteria can be identified from their shapes, i.e. uniformly dispersed rod-shaped cells of around 1.6×0.5|μm. However, on the addition of the γ-Al₂O₃ nanoparticles the cells of the PF bacteria cannot be observed. The reason for this is that the surface of the substrates is no longer smooth, see FIG. 4. Nevertheless, evidence that the PF bacteria cells were present was obtained from fluorescence microscopy using ethidium bromide stained samples, see FIG. 5.

### Bacterial Survival

A natural concern with the preparation method used for the bio-active coatings is the presence of alcohol in the sol gel formulation. Given this issue the sol gel system was formulated to minimise the concentrations of solvents used. It is clear from the fluorescence microscopy studies that the P. fragi did survive and was metabolically active during the immersion period as seen from the elongated cells seen in FIGS. 12 and 13. In the case of P. polymyxa the endospore form of the bacteria was chosen since they are known to be resistant to organic solvents and elevated temperatures. Also, it is possible that the presence of dormant endospores may allow viable bacteria to remain in the coating for longer than is possible with vegetative cells.

### Corrosion Behaviour

The benefit of encapsulating ‘protective’ bacteria on the corrosion behaviour of the sol gel coating system was derived by comparing the electrochemical behaviour of control sol gel coated samples immersed in nutrient-rich ASW with and without sessile bacteria present in the electrolyte with that of encapsulated bacteria within the sol gel coating immersed in nutrient-rich ASW. Correlation of the electrochemical data with physical observations of the samples following withdrawal from the solution also supported this benefit, FIG. 13 shows that the abiotic coating (top photos) provides protection for a limited period after which corrosion develops under the coating, as arrowed at days 12, 16 and 30.

Examination of the retrieved field trial samples, FIGS. 14A and 14B, show that the bio-active coating provides significant corrosion protection up to 6 months. The electrochemical data supports the exposure data as shown in FIG. 7. Here the LPR results show that, with the exception of one data point, the polarisation resistance increases when either PF or PP bacteria is present in the coating. Analysis of the data indicates that over the 30 day test period, on average, there is an improvement in corrosion resistance of up to 30 times for the bacteria loaded samples over that of the abiotic coating. FIG. 7 also shows that there is little benefit on corrosion resistance of sessile PP when added to the nutrient rich ASW. The number of bacteria in the freely suspended form was approximately equal to that encapsulated in the coating. Although it might be argued that increasing the density of freely suspended bacteria may result in a corrosion resistance improvement, it is considered that this is not truly reflective of most natural environments and that the effectiveness of the inoculum of bacteria or spores only leads to protection when they are concentrated at the surface.

Initial analysis of the EIS impedance data created some confusion over what seemed to be an inductive loop in the data. In order to address this, a specimen of uncoated 2024T3 Al alloy was tested to acquire some baseline data. It was found that the uncoated specimen also showed this apparently inductive behaviour, at the end of the experiment it was noted that some localised corrosion had taken place on the surface of the uncoated specimen after a period of some 10 hours. It was concluded from this experiment that the apparent inductive loop was a feature of the substrate and could be excluded from the analysis.

FIGS. 8 and 9 present a summary of the impedance data in the form of Nyquist and Bode plots. There is a clear difference in polarisation resistance as indicated by the diameter of the impedance loops. FIG. 8, with the sol gel containing PP showing the greatest corrosion resistance and the sol gel control and sessile test showing similar low corrosion resistance values. This is also reflected in the Bode plot (FIG. 9) where both PF and PP sol gel coatings have higher impedance values. It is also noteworthy that the shape of the Bode plots is the same for all the systems indicating there are no major differences in response other than higher coating resistances for the biotic coatings.

This data is in agreement with the LPR results given in FIG. 7. This is also reflected in Table 2, which presents the charge transfer resistance of the different systems at day 30. Note that the impedance and calculated charges transfer resistance values for the test conducted using freely suspended bacteria (termed “sessile” in table 2) showed consistently low impedance values and was stopped after 12 days. Signs of corrosion of the substrate were also noted on this sample on removal from solution. Table 2 only shows the final Rct value for each system. It was noted that there was an increasing trend in Rct throughout the 30 day immersion period although the cause of this is yet to be established, however some initial comments can be made;

The consequence of introducing the bacteria into the coating may lead to one or all of the following effects;
(i) decrease in the porosity of the coating;
(ii) uptake of water by the bacteria within the film;
(iii) formation of protective corrosion products, formation of corrosion inhibiting species.

Analysis of the ENA data also supports the conclusion that the inclusion of bacteria to the coating caused an increase in corrosion resistance. As with the reciprocal of the polarization resistance value 1/R_{P}, 1/Rₙ can be used as an indicator of relative corrosion rate, but is generally considered more sensitive to localized corrosion processes than 1/R_{P}. For the Al 2024 substrate, the 1/Rn values for the coatings containing PF and PP were found to be smaller than those of the abiotic control coatings. These results are in agreement with both the EIS and LPR data previously presented, which indicate that both strains of bacteria provided additional protection for the Al substrate. The 1/Rp and 1/Rₙ values for each group of test and control disc coupons are shown in Table 3 for comparison.

| | 1/Rₚ(Ω⁻¹ · cm⁻²) | 1/Rₚ(Ω−¹ · cm⁻²) | 1/Rₙ(Ω⁻¹ · cm⁻²) |
|---|---|---|---|
| System | LPR | EIS | ENA |
| Al control | 9.8 × 10⁻⁵ | 5.7 × 10⁻⁵ | 7.7 × 10⁻⁸ |
| AI + PF | 4.5 × 10⁻⁵ | 1.8 × 10⁻⁵ | 7.9 × 10⁻⁹ |
| AI + PP | 3.2 × 10⁻⁵ | 2.8 × 10⁻⁵ | 4.2 × 10⁻⁹ |

This corrosion data is from individual corrosion test methods for the control and bacteria-loaded sol gel coated Al substrate after 30 days immersion.

From the data in Table 3 it can be seen that all three techniques give rise to the same conclusion, namely that incorporation of bacteria into the sol gel causes an increased corrosion resistance of up to ×5 that of an abiotic coating.

As with any coated substrate, the corrosion resistance of the coated systems will depend upon the thickness of the coating. In this study the typical coating thickness of the samples was 5-7 μm. Increasing the thickness would be expected to increase the corrosion resistance. However we know from previous studies where the corrosion behaviour of coated Al 2024 was studied as a function of sol gel film thickness it was observed that once the sol gel film thickness reaches around 5 μm there is no further change in the open circuit potential; an indication that the coating is behaving independently to that of the substrate.

### Biological Aspects

The two bacterial strains that were tested during this study were chosen on the basis of previous work that indicated two mechanisms via which biofilms of ‘protective’ bacteria can inhibit corrosion. Firstly, biofilms of aerobic bacteria such as P. fragi have been shown to inhibit corrosion by reducing the O₂ concentration at the metal surface. Secondly, bacteria that are able to secrete antimicrobial compounds to which SRB are sensitive can inhibit corrosion due to the anaerobic growth of SRB at the material surface. P. polymyxa, which produces the antibiotic polymyxin, is one such bacterium that has the added advantage of being able to form highly resistant endospores that potentially could remain dormant for prolonged periods (e.g. a number of years) before being activated to germinate by nutrients produced due to microbiological activity at the material surface. Cells of P. fragi and endospores of P. polymyxa both significantly improved the corrosion resistance of the sol gel coatings although the relatively small amount of metabolic activity and microbial growth cast significant doubt on whether the corrosion protection functions via the same mechanisms described in the biofilm studies previously cited.

In addition to use of the sol-gel immobilisation system, this disclosure differs from the previously published ones, in that it models real applications of materials are modelled as closely as possible, and so used a relatively nutrient-poor artificial seawater mixture in place of the microbiological growth media used previously and did not use a rigorously axenic test system (since few real applications are free from environmental bacteria). The lack of bacterial activity is almost certainly a result of lack of nutrients but it clearly does not abolish the protective effect of the bacteria in the sol gel coating. Further experimental data may be needed to establish conclusively whether bacterial metabolic activity is required for the protective properties of the coating or whether it is the physicochemical properties of components of the bacterial cells or spores that are responsible.

### CONCLUSIONS

A novel bacteria loaded hybrid sol gel coating has been successfully applied to a commercial aluminium alloy substrate. Atomic Force, Environmental Scanning Electron, Fluorescence and Optical Microscopy have identified that the bacteria is uniformly distributed throughout the coating and that after 30 days immersion in artificial seawater bacterial cells remain metabolically active.

Electrochemical measurements of polarisation resistance, impedance spectroscopy and electrochemical noise all showed a significant positive impact on the corrosion resistance of the coatings in the presence of both P. fragi and P. polymyxa bacteria. This improvement was supported by optical observation of field trial samples following immersion in a tidal estuarine environment for durations up to 6 months for which excess pitting on the uncoated and abiotic coatings was noted compared to the absence of any localised attack on the biotic coated samples.

Although this invention has been described in relation to the inhibition of corrosion at the surface of a metal type substrate, it is also possible that the mixtures of the present invention may be used to inhibit corrosion on a large number of surfaces including diamond, clay and alumina-based sol-gels.

Furthermore, although the invention has been described in relation to anticorrosion coatings, the person skilled in the art will understand that it can be a generally applicable technique of introducing beneficial microorganisms into a mixture to prevent the growth of harmful bacteria on the surface of a substrate.

1. A method for preparing a substrate, the method comprising:
preparing a sol comprising an inorganic oxide particulate;
preparing a suspension comprising a microorganism wherein the microorganism is immobilised within the suspension;
mixing the sol and the suspension together to form a mixture;
coating the substrate with the mixture; and
curing the mixture on the substrate to form a sol-gel derived coating chemically bonded to the substrate;
wherein the microorganism maintains viability within the coating to inhibit microbial induced corrosion or biofouling at the substrate.

2. The method as claimed in claim 1 wherein said mixture is cured at a temperature of less than or equal to 120° C.

3. The method as claimed in claim 1 wherein said mixture is cured at a temperature of less than 50° C.

4. The method as claimed in claim 1 wherein said mixture is cured at room temperature.

5. The method as claimed in claim 1 wherein said microorganism is immobilised by means of encapsulation in said mixture.

6. The method as claimed in claim 1 wherein said microorganism comprises prokaryotic cells.

7. The method as claimed in claim 1 wherein said microorganism comprises archaeal cells.

8. The method as claimed in claim 1 wherein said microorganism comprises bacterial cells.

9. The method as claimed in claim 8 wherein said bacterial cells are vegetative cells.

10. (canceled)

11. The method as claimed in claim 10 wherein said bacterial cells are endospores.

12. (canceled)

13. The method as claimed in claim 1 wherein the volume ratio of said sol to said suspension is 1:10.

14. The method as claimed in claim 1 wherein said mixture has a pH within the range of from 4 to 10.

15. The method as claimed in claim 1 wherein said mixture has a pH of 7.

16. The method as claimed in claim 1 wherein said inorganic oxide particulate comprises any one or a combination of the following set of:
metal oxide nanoparticles;
alumina-based nanoparticles;
silica based particulates;
an ormosil or ormosil hybrid.

17. The method as claimed in claim 1 wherein said inorganic oxide particulates comprise a mixture of tetraethylorthosilicate, methyltrimethoxysilane and 3-glycidoxypropyltrimethyoxysilane.

18. The method as claimed in claim 17 wherein the ratio of said mixture of tetraethylorthosilicate, methyltrimethoxysilane and 3-glycido-oxypropyltrimethyoxysilane is 10:6:1.

19. The method as claimed in claim 1 wherein said suspension further comprises a buffering agent.

20. The method as claimed in claim 1 wherein said sol further comprises a curing agent.

21. The method as claimed in claim 1 wherein said sol comprises a thickening agent.

22. The method as claimed in claim 1 wherein said coating is configured to inhibit the development of microbial induced corrosion.

23. The method as claimed in claim 1 wherein said coating is configured to inhibit corrosion caused by sulphate reducing bacteria.

24. (canceled)

25. A substrate comprising a coating configured to protect the substrate from microbial induced corrosion or biofouling, the coating comprising:
a sol-gel derived inorganic oxide network resultant from condensation reactions between inorganic oxide particulates; and
a microorganism incorporated within the coating, the microorganism capable of reacting chemically with microbes responsible for microbial induced corrosion or biofouling and configured to inhibit the biological activity of said microbes.

26. The substrate as claimed in claim 25 wherein said microorganism is chemically bonded to the substrate.

27. The substrate as claimed in claim 25 wherein the microorganism is encapsulated within the coating.

28. The substrate as claimed in claim 25 wherein the microorganism is incorporated within the coating so as to inhibit the microorganism from leaching out of the coating once the coating is exposed to an aqueous environment.

29. The substrate as claimed in claim 25 wherein said microorganism comprises prokaryotic cells.

30. The substrate as claimed in claim 25 wherein said microorganism comprises archaeal cells.

31. The substrate as claimed in claim 25 wherein said microorganism comprises bacterial cells.

32. The substrate as claimed in claim 31 wherein said bacterial cells are vegetative cells.

33. (canceled)

34. The substrate as claimed in claim 31 wherein said bacterial cells are endospores.

35. (canceled)

36. The substrate as claimed in claim 25 wherein the coating is alumina-based.

37. The substrate as claimed in claim 25 wherein the coating is silica-based.

38. The substrate as claimed in claim 25 wherein the coating is ormosil-based.

39. The substrate as claimed in claim 25 wherein the substrate comprises a metal selected from any one or a combination of the following:
Iron;
Aluminium;
Titanium;
Copper;
Silver.

40. The substrate as claimed in claim 25 wherein said substrate is a metal alloy selected from the following:
Steel;
Magnesium alloy;
Aluminium alloy;
Stainless steel;
Titanium alloy;
Copper alloy;
Silver alloy.

41. The substrate as claimed in claim 25 wherein said microorganism is configured to inhibit corrosion caused by sulphate reducing bacteria.

42. The substrate as claimed in claim 25 wherein the substrate comprises any one or a combination of the following:
a plastic based material;
a polymer based material;
Fiberglass.
